(19) United States
(12) Patent Application Publication
(10) Pub. No.: US 2009/0175479 A1
(43) Pub. Date: Jul. 9, 2009

(54) Microphone package, lead frame, mold substrate, and mounting structure therefor

(75) Inventor: Kenichi Shirasaka, Aira-gun (JP)

Correspondence Address: PILLSBURY WINTHROP SHAW PITTMAN LLP, P.O BOX 10500, McLean, VA, 22102, US

(73) Assignee: Yamaha Corporation, Hamamatsu-shi (JP)

(21) Appl. No.: 12/319,316

(22) Filed: Jan. 6, 2009

(30) Foreign Application Priority Data
Jan. 9, 2008 (JP) 2008-002411

(51) Int. Cl. H04R 1/02

(52) U.S. Cl. 381/361; 381/360

(57) ABSTRACT

A microphone package is constituted of a cover and a mold substrate that is formed in accordance with the resin mold technology so as to form a cavity for embracing a microphone chip. The mold substrate is constituted of a stage having conductivity and a rectangular shape for mounting a microphone chip thereon, a plurality of lead terminals having conductivity and electrically connected to the microphone chip, and a resin mold for electrically insulating the stage from the lead terminals. A sound hole is formed in the mold substrate by use of a cylindrical projection which projects from the backside of the stage and whose distal surface is exposed from the backside of the mold substrate. When the microphone package is mounted on the mounting surface of an external substrate, it is possible to prevent sound from being leaked via gaps therebetween.

### BACKGROUND OF THE INVENTION

1. Field of the Invention

The present invention relates to microphone packages, lead frames, and mold substrates for encapsulating microphone chips.

The present invention also relates to mounting structures adapted to microphone packages.

The present application claims priority on Japanese Patent Application No. 2008-2411, the content of which is incorporated herein by reference.

2. Description of the Related Art

Conventionally, various technologies regarding miniature condenser microphones and packages have been developed and disclosed in various documents such as Patent Documents 1 and 2.

Patent Document 1: Japanese Patent Application Publication No.

Patent Document 2: U.S. Pat. No. 6,781,231

Patent Document 1 teaches a microphone package in which a microphone chip for detecting sound is installed in a housing having a sound hole and a hollow cavity. The housing is constituted of a multilayered wiring substrate such as a printed substrate and a ceramic substrate for mounting the microphone chip on the surface thereof and a cover for covering the multilayered wiring substrate mounting the microphone chip.

External terminals which are electrically connected to the microphone chip are formed on the exterior surface of the multilayered wiring substrate. In the mounting process for mounting the microphone package on a substrate (or a board), the exterior surface of the multilayered wiring substrate is positioned opposite to the mounting surface of the substrate, and then the external terminals of the multilayered wiring substrate are bonded to lands of the substrate via solder.

This type of microphone package may have a through-hole (serving as the sound hole) running through the multilayered wiring substrate from the surface to the backside. According to the teaching of Patent Document 2, the microphone package is mounted on the substrate (or board) in such a way that the sound hole thereof is positioned opposite to a through-hole running through the substrate in its thickness direction. That is, when the microphone package is completely mounted on the mounting surface of the substrate, sound is forced to enter into the cavity via the sound through-hole and the sound hole.

A gap formed between the microphone package and the substrate may allow sound to be leaked therefrom when sound is propagated from the through-hole to the sound hole. In order to avoid sound leakage, Patent Document 2 teaches that a solder is formed in a ring shape surrounding the opening of the sound hole on the exterior surface of the multilayered wiring substrate, wherein it is necessary to additionally form plating on the surface of the ring-shaped solder surrounding the sound hole on the exterior surface of the multilayered wiring substrate.

Generally speaking, multilayered wiring substrates for use in housings of microphone packages are relatively costly. In addition, it is necessary to further increase the number of steps of manufacturing microphone packages when ring-shaped solders surrounding sound holes are formed and subjected to plating. This is very troublesome in manufacturing microphone packages, thus pushing up the manufacturing costs.

### SUMMARY OF THE INVENTION

It is an object of the present invention to provide a microphone package which is easily manufactured with relatively low cost by use of resin mold technology.

It is another object of the present invention to provide a lead frame and a mold substrate for use in the microphone package.

It is a further object of the present invention to provide a mounting structure adapted to the microphone package.

A microphone package of the present invention is constituted of a housing having a hollow cavity and a sound hole and a microphone chip which is arranged inside the housing so as to detect pressure variations applied thereto via the sound hole. The housing includes a mold substrate for mounting the microphone chip on the surface thereof, and a cover having a rectangular shape, which is combined with the mold substrate so as to form the hollow cavity for embracing the microphone chip. The mold substrate includes a stage having conductivity for mounting the microphone chip thereon, a plurality of lead terminals having conductivity, which are electrically connected to the microphone chip, and a resin mold having an insulating property, which electrically insulates the stage from the lead terminals. The sound hole is formed by way of a cylindrical projection which integrally projects from the backside of the stage and whose distal surface is exposed externally from the backside of the resin mold.

A mounting structure is adapted to the microphone package mounted on the mounting surface of a substrate which includes a through-hole positioned opposite to the sound hole of the mold substrate, at least one land electrically connected to a ground terminal and the lead terminals, and a joint land which is formed in the surrounding area of the through-hole and is positioned opposite to the distal surface of the cylindrical projection which is joined with the joint land via solder.

When the microphone package is mounted on the mounting surface of the package, the backside of the mold substrate is positioned to face the mounting surface, and then the ground terminal and lead terminals are soldered to the land of the substrate, whereby the microphone chip is electrically connected to the substrate via the lead terminals.

In the above, the sound hole of the mold substrate is positioned opposite to the through-hole of the substrate, and then the distal surface of the cylindrical projection is soldered to the joint land of the substrate. In this state, pressure variations such as sound are introduced into the cavity via the through-hole and the sound hole, wherein the solder for bonding the distal surface of the cylindrical projection and the joint land of the substrate prevents pressure variations from being leaked via gaps between the backside of the mold substrate and the mounting surface of the substrate.

In the microphone package, the stage and the lead terminals are formed using a lead frame composed of a thin metal plate.

In the above, the cover having conductivity is formed in a box shape having a bottom portion and an opening edge, and a plurality of cutouts is formed in the periphery of the stage. Herein, the lead terminals are constituted of connectors, which are arranged inside the cutouts and whose internal connection surfaces are exposed in the cavity and are electrically connected to the microphone chip, and support leads which are extended externally from the connectors in the periphery of the stage and whose distal ends are exposed on the side surface of the mold substrate. In addition, a plurality of recesses is formed on the support leads in width directions and is sealed with the resin mold. Furthermore, the opening edge of the cover is mounted on the surface of the stage and the resin mold embedded in the recesses of the support leads.

By electrically connecting the stage to the ground pattern of the substrate, it is possible to form a shield which is defined by the stage and the cover so as to block noise from entering into the cavity. Since the opening edge of the cover is directly mounted on the surface of the stage while securing an electrically insulating state between the cover and the lead terminals, the above shield can entirely cover the cavity except for the cutouts, in which the stage is not brought into contact with the lead terminals, and the sound hole. This minimizes gaps allowing noise to enter into the cavity, thus improving the shield performance of the microphone package.

The mold substrate applied to the microphone package is constituted of the stage having a rectangular shape for mounting the microphone chip on the surface thereof, a plurality of lead terminals which are aligned in proximity to the stage with gaps therebetween and are electrically connected to the microphone chip, and a resin mold having an insulating property which electrically insulates the stage from the leads. Herein, each of the lead terminals has an internal connection surface which is exposed externally of the resin mold formed above the surface of the stage, and an external connection surface which is exposed externally of the resin mold below the backside of the stage. In addition, a cylindrical projection having a through-hole, which runs through the stage in the thickness direction, is integrally formed to project from the backside of the stage. Furthermore, the distal surface of the cylindrical projection is exposed externally of the resin mold below the backside of the stage.

The lead frame for use in the mold substrate is constituted of the stage, a plurality of lead terminals, and a plurality of interconnection leads for integrally unifying the lead terminals to the stage, wherein the cylindrical projection having a through-hole, which runs through the stage in the thickness direction, is integrally formed to project from the backside of the stage.

In the manufacturing of the mold substrate using the lead frame, the stage and the lead terminals are sealed with the resin mold such that the surface of the stage, the internal connection surfaces and external connection surfaces of the lead terminals, and the distal surface of the cylindrical projection are externally exposed from the resin mold, wherein the resin mold is not formed in the through-hole of the cylindrical projection. In this connection, the interconnection leads can be formed inside the resin mold or externally of the resin mold. After the formation of the resin mold, the interconnection leads are subjected to cutting so as to electrically insulate the stage from the lead terminals.

In short, since the distal surface of the cylindrical projection is integrally formed with the stage in the surrounding area of the sound hole so as to avoid sound leakage, it is possible to easily manufacture the microphone package at low cost and avoid sound leakage.

### BRIEF DESCRIPTION OF THE DRAWINGS

These and other objects, aspects, and embodiments of the present invention will be described in more detail with reference to the following drawings.

FIG. 1 is a plan view of a microphone package according to a first embodiment of the present invention in view of the surface of a resin mold.

FIG. 2 is a back view of the microphone package in view of the backside of the resin mold.

FIG. 3 is a sectional view taken along line A-A in FIGS. 1 and 2.

FIG. 4 is a sectional view taken along line B-B in FIGS. 1 and 2.

FIG. 5 is a plan view showing the surface of a thin metal plate used for the formation of a lead frame.

FIG. 6 is a plan view showing the backside of the thin metal plate subjected to half-etching.

FIG. 7 is a sectional view showing that the surface and backside of the thin metal plate are covered with resist films prior to half-etching.

FIG. 8 is a sectional view showing the progression of half-etching on the thin metal plate.

FIG. 9 is a sectional view of the lead frame which is formed by way of half-etching.

FIG. 10 is a sectional view used for explaining a molding process for sealing the lead frame with the resin mold by use of a pair of metal molds.

FIG. 11 is a sectional view showing that the lead frame is tightly held between the metal molds.

FIG. 12 is a plan view showing the lead frame sealed with the metal mold from the perspective of a surface view of the thin metal plate.

FIG. 13 is a plan view showing the lead frame sealed with the metal mold from the perspective of a backside view of the thin metal plate.

FIG. 14 is a sectional view taken along line C-C in FIGS. 12 and 13.

FIG. 15 is a sectional view showing that the microphone package is mounted on the mounting surface of a substrate.

FIG. 16 is an enlarged sectional view showing a modification of the microphone package in which a connector of a lead terminal installed in a stage of the lead frame is reduced in thickness.

FIG. 17 is a plan view showing a microphone package according to a second embodiment of the present invention.

FIG. 18 is a sectional view taken along line D-D in FIG. 17.

FIG. 19 is a sectional view taken along line E-E in FIG. 17.

FIG. 20 is an enlarged sectional view showing a modification of the lead terminal sealed with the resin mold.

FIG. 21 is an enlarged sectional view showing another modification of the lead terminal sealed with the resin mold.

### DESCRIPTION OF THE PREFERRED EMBODIMENTS

The present invention will be described in further detail by way of examples with reference to the accompanying drawings.

### 1. First Embodiment

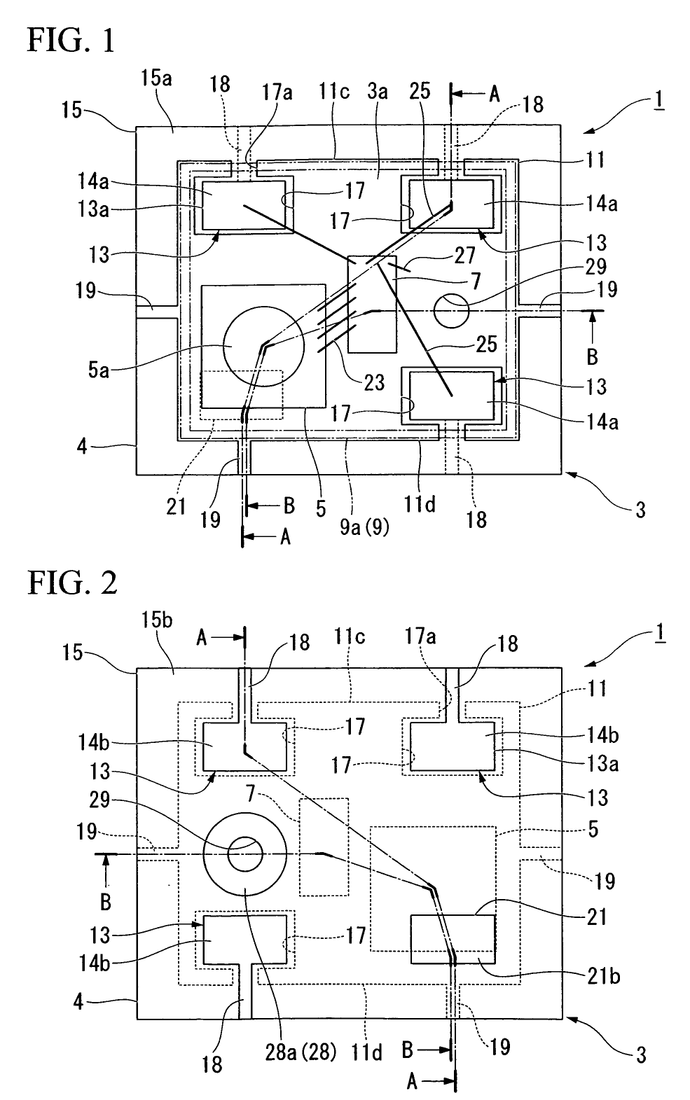

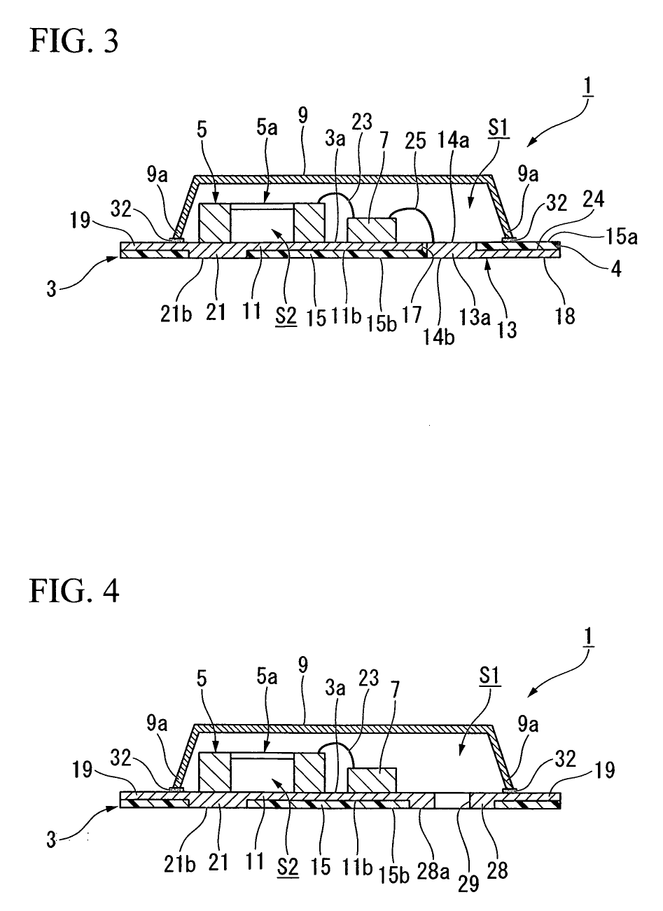

A microphone package 1 according to a first embodiment of the present invention will be described with reference to FIGS. 1 to 13. The microphone package 1 is used to detect pressure variations such as sounds generated in the external space and is formed as a surface mount package which is manufactured using a lead frame in accordance with the resin mold technology.

As shown in FIGS. 1 to 4, the microphone package 1 is constituted of a mold substrate 3 having a rectangular plate shape in plan view, a microphone chip (or a semiconductor chip) 5 and a companion chip 7 both mounted on a surface 3a of the mold substrate 3, and a cover 9 which is combined with the mold substrate 3 so as to cover the microphone chip 5 and the companion chip 7.

The mold substrate 3 is constituted of a stage 11 having a rectangular plate shape for forming the surface 3a of the mold substrate 3, a plurality of leads (e.g. three lead terminals) 13 for electrically connecting the microphone chip 5 and the companion chip 7, and a resin mold (or an insulating member) 15 for electrically insulating the stage 11 from the lead terminals 13. Both the stage 11 and the leads 13 are unified together in the form of a lead frame, which is formed using a thin metal plate having conductivity.

The surface 3a (corresponding to the surface of the stage 11) is exposed on a surface 15a of the resin mold 15, while a backside 11b of the stage 11 and a part of its side surface are covered with the resin mold 15. Both the surface of the stage 11 and the surface 15a of the resin mold 15 are placed in a single plane so as to form the surface 3a of the mold substrate 3 for mounting the microphone chip 5 and the companion chip 7 thereon.

A plurality of cutouts (e.g. three cutouts or recesses which are horizontally enlarged) 17 are formed inwardly in the periphery of the stage 11 so as to embrace the lead terminals 13 therein. Each cutout 17 has a rectangular portion and a narrow channel having an opening 17a, the width of which is smaller than the width of the rectangular portion. In the first embodiment, the two cutouts 17 are aligned along a first side 11c of the rectangular-shaped stage 11, while one cutout 17 is positioned along a second side 11d (which is opposite to the first side 11c) of the stage 11 and is also positioned opposite to one of the two cutouts 17 aligned along the first side 11c.

A plurality of interconnection leads (e.g. three interconnection leads) 19, each of which is elongated to a side surface 4 of the resin mold 15, is integrally formed with the stage 11. The interconnection leads 19 are exposed on the surface 15a of the resin mold 15 together with the surface 3a of the stage 11.

In the first embodiment, one interconnection lead 19 is formed to adjoin one cutout 17 along the second side 11d of the stage 11 and is positioned opposite to the other of the two cutouts 17 formed along the first side 11c of the stage 11. The other two interconnection leads 19 are respectively formed along the other sides perpendicular to the first side 11c and the second side 11d of the stage 11 and are thus positioned opposite each other.

A ground terminal 21 is integrally formed in the stage 11 so as to project downwardly from the backside 11b, wherein the distal end thereof is exposed externally from the resin mold 15. Specifically, an external connection surface 21b of the ground terminal 21 is placed in a same plane with a backside 15b of the resin mold 15 (corresponding to the backside of the mold substrate 3). The ground terminal 21 is electrically connected to a ground pattern of a substrate (or a board, not shown) for mounting the microphone package 1 via solder.

A projection 28 having a cylindrical shape (see FIG. 1 and 4) is integrally formed with the stage 11 so as to project downwardly from the backside 11b.

The projection 28 having a through-hole (i.e. a sound hole) 29 runs through the stage 11 in its thickness direction, wherein a distal surface 28a thereof is exposed externally from the resin mold 15 similar to the ground terminal 21 so as to form the same plane with the backside 15b of the resin mold 15.

Each lead terminal 13 which is positioned inside each cutout 17 of the stage 11 is constituted of a connector 13a having an interior connection surface 14a, which is electrically connected to the companion chip 7, and a support lead 18 having a plate-like shape which is elongated externally from the stage 11 without contact with the stage 11. The support lead 18 is laid in the opening 17a of the cutout 17 and is elongated externally from the periphery of the stage 11 such that the distal end thereof is exposed on the side surface 4 of the resin mold 15. The width of the support lead 18 is smaller than the width of the connector 13 of the lead terminal 13.

Each lead terminal 13 has an external connection surface 14b which is exposed externally from the backside 15b of the resin mold 15 and is electrically connected to the external wiring (not shown). The external connection surface 14b forms the same plane with the backside 15b of the resin mold 15.

All the lead terminals 13 are unified together such that one surface thereof forms the internal connection surface 14a while the other surface thereof forms the external connection surface 14b. When the microphone package 1 is mounted on a substrate (or a board, not shown), they serve as external connection terminals for electrically connecting the microphone chip 5 and the companion chip 7 to the external wiring (i.e. connection terminals of the substrate, not shown) via solder.

The stage 11, the support leads 18, and the interconnection leads 19 are partially reduced in thickness compared with the thickness of the mold substrate 3 by way of half-etching applied to the thin metal plate.

Specifically, etching is performed on the surface (lying in correspondence to the surface 3a of the stage 11) of the thin metal plate (whose backside lies in correspondence with the internal connection surface 14a) so as to reduce the original thickness by half approximately, whereby the support leads 18 of the lead terminals 13 are formed using the half-thickness portion of the thin metal plate. This allows the support leads 18 to be located below the surface 3a of the stage 11. In addition, hollows 24 which are used to mount the cover 9 are formed in the support leads 18 of the mold substrate 3 in the entirety.

The stage 11 and the interconnection leads 19 are formed by etching the backside of the thin metal plate, the thickness of which is reduced by half approximately. The prescribed portions of the stage 11 corresponding to the areas of the ground terminal 21 and the projection 28 are not subjected to half-etching, whereby the thickness of the stage 11 in these areas accompanied with the ground terminal 21 and the projection 28 is identical to the original thickness of the thin metal plate. That is, the thickness of the stage in the areas of the ground terminal 21 and the projection 28 is identical to the thickness of the resin mold 15 formed inside the cutout 17. The projection 28 and the through-hole 29 are formed by etching both of the surface and backside of the thin metal plate.

The connectors 13a of the lead terminals 13 are not subjected to half-etching; hence, the thickness thereof is identical to the original thickness of the thin metal plate.

The resin mold 15 is composed of an electrically insulating material and is formed in connection with the backside 11b of the stage 11, the backsides of the interconnection leads 19, and the recesses 24 of the support leads 18, wherein the resin mold 15 is also embedded in gaps between the lead terminals 13 and the cutouts 17 of the stage 11. The resin mold 15 is formed to expose the surface 13a of the stage 11 and the internal connection surfaces 14a of the lead terminals 13 externally from the surface 15a thereof while exposing the external connection surfaces of the lead terminals 13 and the external connection surface 21b of the ground terminal 21 from the backside 15b thereof.

The thickness of the resin mold 15 embedded in gaps between the lead terminals 13 and the cutouts 17 of the stage 11 is identical to the original thickness of the thin metal plate before half-etching, whereby the overall thickness of the mold substrate 3 is identical to the original thickness of the thin metal plate.

The cover 9 is composed of a conductive material such as copper and is formed in a rectangular box shape having an opening and bottom. The cover 9 is combined with the mold substrate 3 so as to embrace the microphone chip 5 and the companion chip 7 therein, thus forming a housing having a hollow cavity S. An opening edge 9a of the cover 9 lies on the periphery of the surface 3a of the stage 11 and the periphery of the resin mold 15 formed in the openings 17a of the cutouts 17. The opening edge 9a of the cover 9 is bonded onto the surface 3a of the stage 11 via a conductive adhesive 32, whereby the stage 11 is electrically connected to the cover 9.

The support leads 18 embraced in the openings 1 7a of the cutouts 17 are covered with the resin mold 15 whose surface 15a forms the same plane with the surface 3a of the stage 11 and are not exposed from the surface 3a of the stage 11, whereby the lead terminals 13 are electrically insulated from the cover 9.

When the cover 9 is attached to the mold substrate 3, it is possible to form the hollow cavity S1 embracing the microphone chip 5 and the companion chip 7. In other words, the cover 9 and the mold substrate 3 form the housing having the hollow cavity S1.

Both the surface 3a of the stage 11 and the internal connection surfaces 14a of the connectors 13a of the lead terminals 13 are exposed inside the cavity S1 from the surface 15a of the resin mold 15. That is, the internal connection surfaces 14a which are electrically insulated from the stage 11 are exposed inside the housing. The cavity S1 of the housing communicates with the external space via the through-hole 29 of the mold substrate 3. That is, the through-hole 29 of the mold substrate 3 forms a sound hole of the housing.

The microphone chip 5 is composed of silicon and is designed to convert pressure variations such as sounds into electric signals, wherein it has a sound detector 5a that vibrates in response to pressure variations. The microphone chip 5 translates the vibration of the sound detector 5a into variations of electric resistance, whereby variations of resistance or capacitance are converted into electric signals.

The microphone chip 5 is bonded onto the stage 11 via an insulating adhesive paste (not shown) in such a way that the sound detector 5a is positioned opposite to the surface 3a of the stage 11. A cavity S2 is formed between the sound detector 5a of the microphone chip 5 and the surface 3a of the stage 11.

The companion chip 7 functions to drive and control the microphone chip 5, wherein it includes an amplifier for amplifying electric signals of the microphone chip 5, an A/D converter for converting electric signals into digital signals, and a digital signal processor (DSP). The companion chip 7 is fixed onto the surface 3a of the stage 11 via an insulating adhesive paste (not shown) similar to the microphone chip 5.

The companion chip 7 is electrically connected to the microphone chip 5 via first wires 23 (forming a part of the internal wiring) and is also electrically connected to the internal connection surfaces 14a of the lead terminals 13 via second wires 25 (forming another part of the internal wiring). In addition, the companion chip 7 is electrically connected to the surface 3a of the stage 11 via a third wire 27. Thus, the microphone chip 5 is electrically connected to the lead terminals 13 and the stage 11 by way of the companion chip 7.

The microphone package 1 having the above constitution introduces pressure variations such as sounds into the cavity S1 via the through-hole 29 of the mold substrate 3 toward the sound detector 5a.

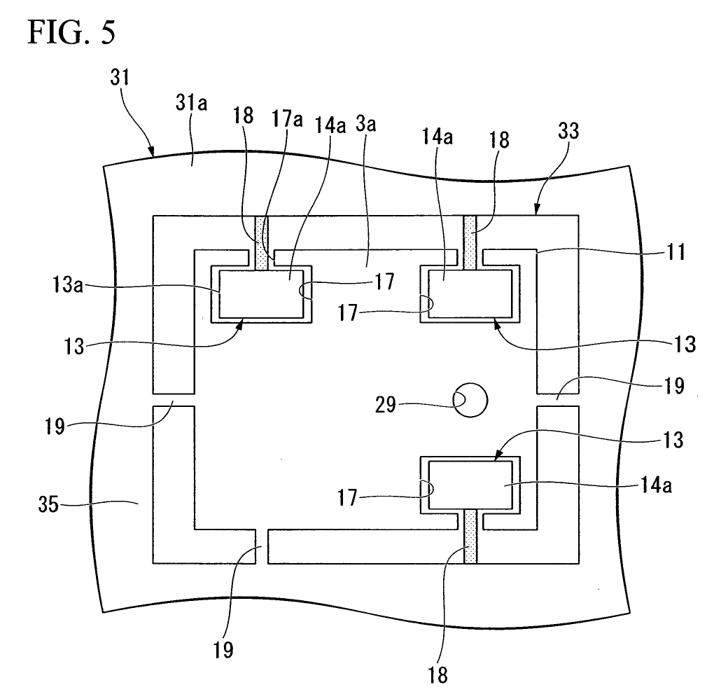

Next, a manufacturing method of the microphone package 1 will be described with reference to FIGS. 5 to 14.

In the manufacturing of the microphone package 1, a mold substrate forming process is performed to produce the mold substrate 3, wherein, in a lead frame forming process as shown in FIG. 5, a thin metal plate 31 composed of copper is subjected to press working and etching so as to form a lead frame 33 in which the lead terminals 31 and the interconnection leads 19 project inwardly of a frame 35 while the interconnection leads 19 are integrally interconnected to the stage 11 (having a rectangular shape in plan view) which is arranged inside the frame 35. In the lead frame 33, the frame 35 and the interconnection leads 19 form an interconnection section for integrally interconnecting the stage 11 and the lead terminals 13.

In the lead frame forming process, the cutouts 17 are formed in the stage 11 in such a way that they are recessed inwardly from the periphery of the stage 11 whose surface 3a matches a surface 3 la of the thin metal plate 31, while the connectors 13a of the lead terminals 13 and a part of the support leads 18 are arranged inside the cutouts 17 such that they do not come in contact with the stage 11. That is, the lead terminals 13 are insulated from the stage 11 and are arranged inside the cutouts 17, which are recessed inwardly from the periphery of the stage 11, such that they are isolated from each other with predetermined distances securing the molding using a resin while exposing the internal connection surfaces 14a and the external connection surfaces 14b thereof.

Next, a half-etching process is performed on the support leads 18 of the lead terminals 13, the stage 11, and the interconnection leads 19. Specifically, the half-etching is performed on the surface 31 a of the thin metal plate 31 so as to reduce the thickness of the support leads 18 (see hatching areas in FIG. 5) compared to the original thickness of the thin metal plate 31. Thus, small recesses for mounting the opening 9a of the cover 9 are formed in the support leads 18.

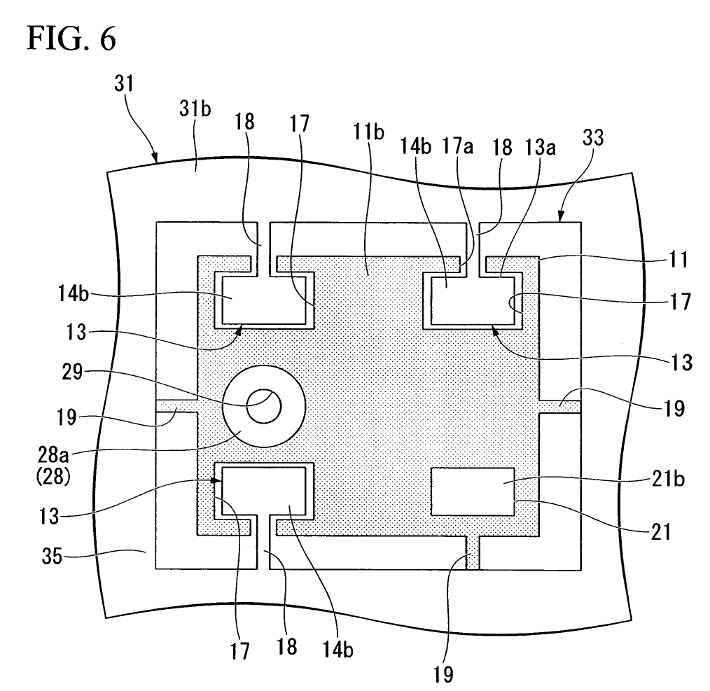

The half-etching is also performed on a backside 31b of the thin metal plate 31 so as to reduce the thicknesses of the stage 11 and the interconnection leads 19 (see hatching areas in FIG. 6) except for the prescribed areas for forming the ground terminal 21 and the projection 28 in comparison with the original thickness of the thin metal plate 31.

The through-hole 29 of the projection 28 can be formed by way of either the lead frame forming process or the half-etching process. For example, the through-hole 29 is formed in the lead frame forming process, and then the outline of the projection 28 is formed in the half-etching process. The half-etching process can be performed simultaneously with the lead frame forming process. Alternatively, the half-etching process is performed before or after the lead frame forming process. Only a single lead frame 33 can be extracted from a single thin metal plate 31; or a plurality of lead frames 33 can be extracted from the thin metal plate 31.

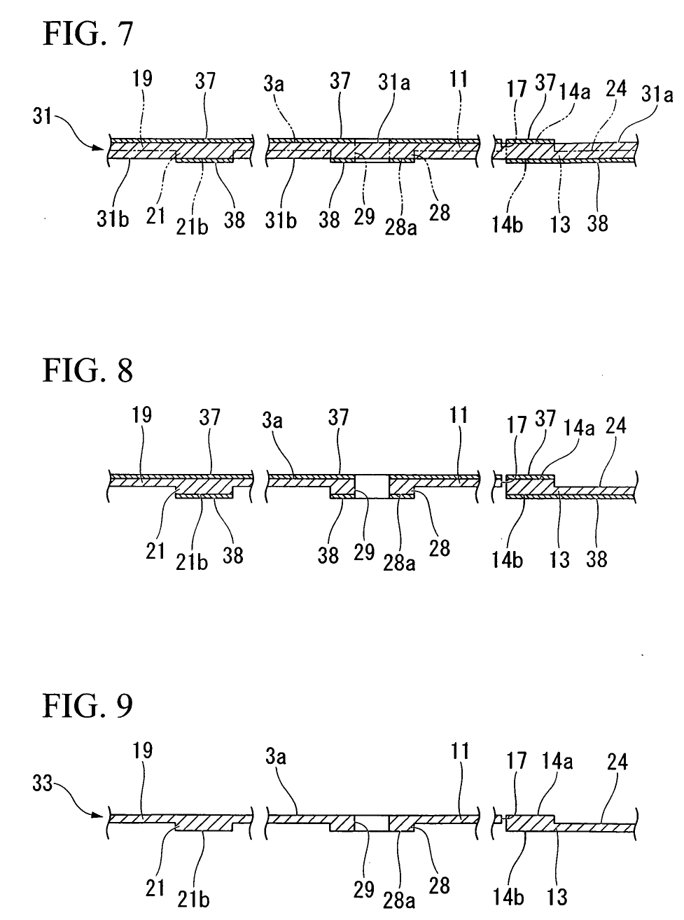

When the lead frame forming process and the half-etching process are performed simultaneously, the lead frame 33 shown in FIGS. 5 and 6 can be formed by way of etching. In this case, as shown in FIG. 7, a resist film 37 is formed on the surface 3a of the stage 11, the internal connection surfaces 14a of the lead terminals 13, and the surfaces of the interconnection leads 19 (which are interconnected with the surface 3a of the stage 11) within the surface 31a of the thin metal plate 31. In addition, a resist film 38 is formed on the external connection surfaces 14b of the lead terminals 13, the external connection surface 21b of the ground terminal 21, and the distal surface 28a of the projection 28 within the backside 31b of the thin metal plate 31.

Next, as shown in FIG. 8, the surface 31a and the backside 31b of the thin metal plate 31 are subjected to half-etching, wherein the prescribed areas of the surface 31a and the backside 31b, which are not covered with the resist film 37 and 38 are selectively etched, thus simultaneously forming the stage 11 (which is isolated from the frame 35 with gaps therebetween), the cutouts 17 of the stage 11, the recesses 24 of the lead terminals 13, and the through-hole 29 of the projection 28. Thereafter, as shown in FIG. 9, the resist films 37 and 38 are removed from the thin metal plate 31, thus completely forming the lead frame 33 shown in FIGS. 5 and 6.

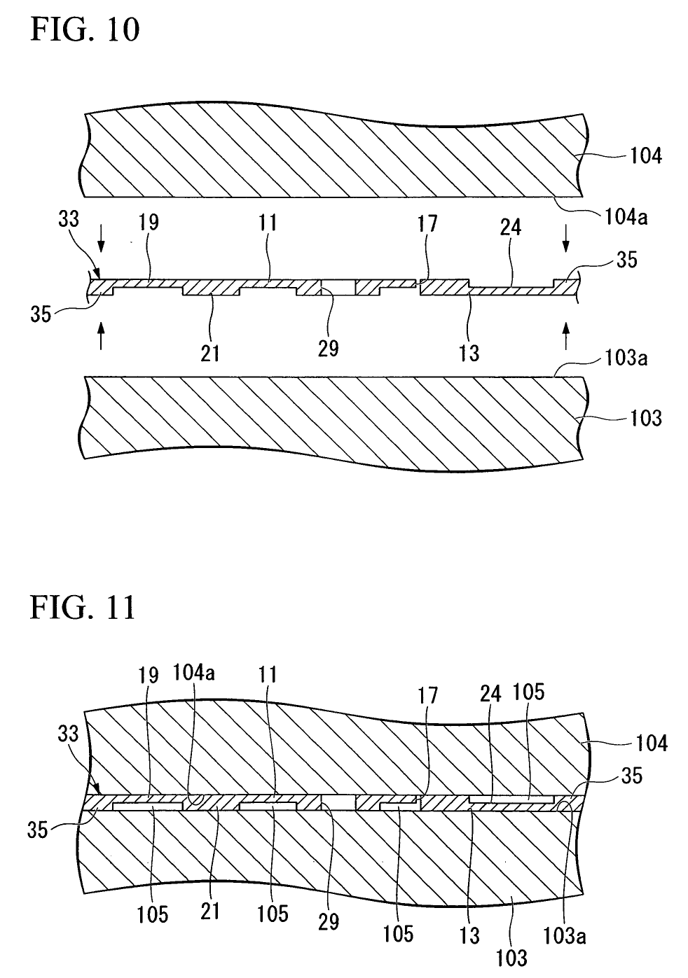

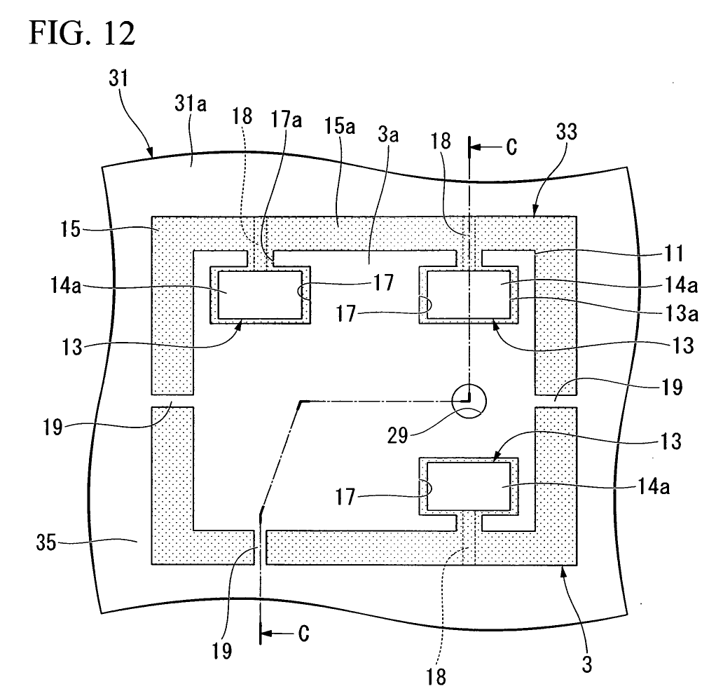

After completion of the lead frame forming process and the half-etching process, a molding process (see FIGS. 10 to 14) is performed so as to seal the lead frame 33 with the resin mold 15. In the molding process, as shown in FIGS. 10 and 11, a pair of metal molds 103 and 104 (used for the formation of the resin mold 15) is prepared to hold the lead frame 33 therebetween. When the lead frame 33 is tightly held between the metal molds 103 and 104 as shown in FIG. 11, cavities 105 are formed between the thinned portions of the lead frame 33 (which are reduced in thickness compared to the original thickness of the thin metal plate 31 by way of half-etching) and “planar” interior surfaces 103a and 104a of the metal molds 103 and 104. The cavities 105 are filled with a resin (or an insulating material), thus forming the resin mold 15 as shown in FIGS. 12 to 14.

Even when the lead frame 33 is sealed with the resin mold 15, the surface 3a of the stage 11, the internal connection surfaces 14a and the external connection surfaces 14b of the lead terminals 13, the external connection surface 21b of the ground terminal 21, and the distal surface 28a of the projection 28 are exposed externally from the surface 15a and the backside 15b of the resin mold 15. Since the through-hole 29 is closed by the internal surfaces 103a and 104a of the metal molds 103 and 104, a part of the resin mold 15 is embedded in the through-hole 29.

Thereafter, a cutting process is performed to separate the lead terminals 13 and the interconnection leads 19, which are sealed with the resin mold 15, from the frame 35 positioned externally of the resin mold 15. The stage 11 is electrically insulated from the lead terminals 13, thus completing the production of the mold substrate 3. Due to the separation, a part of the resin mold 15 embedded in gaps between the stage 11 and the frame 35 is cut out so that the distal ends of the support leads 18 and the interconnection leads 19 are exposed on the cut surfaces.

In FIG. 12, hatching areas indicate the formation of the resin mold 15 in view of the surface 3a of the stage 11. As shown in FIGS. 12 and 14, the surface 3a of the stage 11, the internal connection surfaces 14a of the connectors 13a of the lead terminals 13, and the interconnection leads 19 are exposed from the resin mold 15 so as to form the same plane with the surface 15a. Gaps between the stage 11 and the frame 35 and gaps between the cutouts 17 of the stage 11 and the lead terminals 13 having the connectors 13a and the support leads 18 are filled with resins. In addition, the surfaces of the support leads 18 are covered with the resin mold 15.

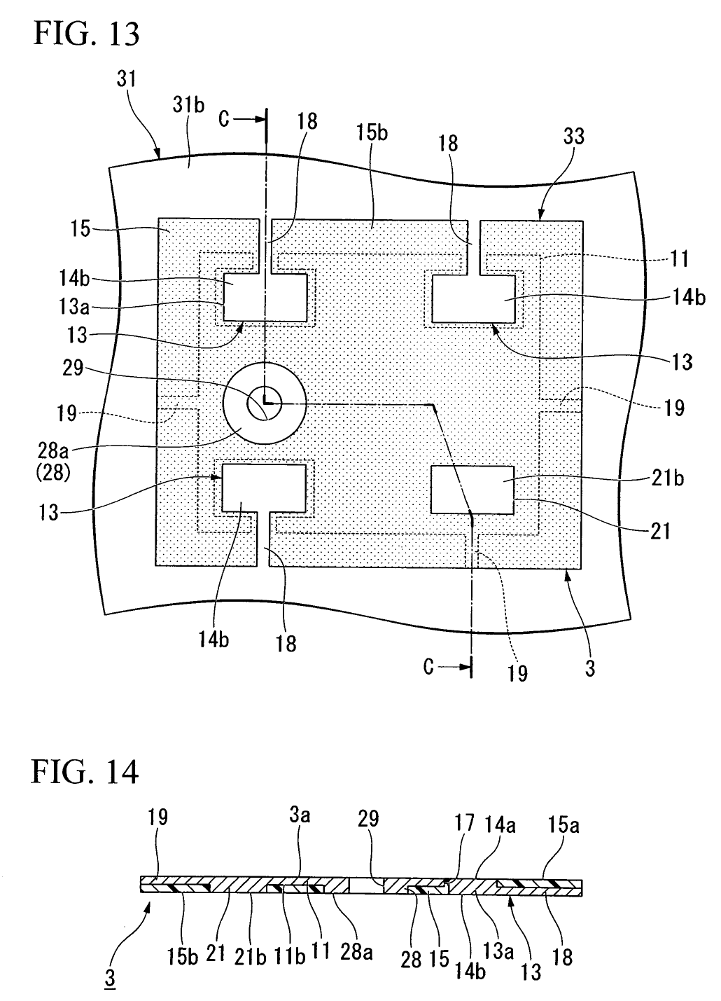

In FIG. 13, hatching areas indicate the formation of the resin mold 15 in view of the backside 11b of the stage 11. As shown in FIGS. 13 and 14, the external connection surfaces 14b of the lead terminals 13, the external connection surface 21b of the ground terminal 21, and the distal end 28a of the projection 28 are exposed from the resin mold 15 so as to form the same plane with the backside 15b. In addition, the backside 11b of the stage 11 and the backsides of the interconnection leads 19 are covered with the resin mold 15.

Thus, it is possible to form the mold substrate 3 whose thickness is identical to the original thickness of the thin metal plate 31 in the mold substrate forming process.

After completion of the mold substrate forming process, a chip mount process is performed so as to fixedly mount the microphone chip 5 and the companion chip 7 on the surface 3a of the stage 11 as shown in FIGS. 1 to 4. In addition, an electric connection process is performed so as to electrically connect the microphone chip 5 to the companion chip 7 via the first wires 23, to electrically connect the companion chip 7 to the internal connection surfaces 14a of the lead terminals 13 via the second wires 25, and to electrically connect the companion chip 7 to the surface 3a of the stage 11 via the third wire 27 by way of wire bonding.

Thereafter, a cover mounting process is performed so that the opening edge 9a of the cover 9 is fixed to the periphery of the surface 3a of the stage 11 so as to enclose the microphone chip 5 and the companion chip 7 therein, thus completing the production of the microphone package 1.

In the cover mounting process, the cover 9 is fixed to the stage 11 via the conductive adhesive 32. Herein, the opening edge 9a of the cover 9 partially lies across the openings 17a of the cutouts 17 in width directions, wherein the support leads 18 are entirely formed in the recesses 24 of the lead terminals 13 and are thus lowered in elevation in comparison with the surface 3a of the stage 11. In addition, the upper portions of the support leads 18 are sealed with the resin mold 15. This reliably prevents the lead terminals 13 from easily coming in contact with the cover 9.

The manufacturing method of the microphone package 1 can be modified such that the cutting process of the mold substrate forming process is performed between the chip mount process and the cover mount process.

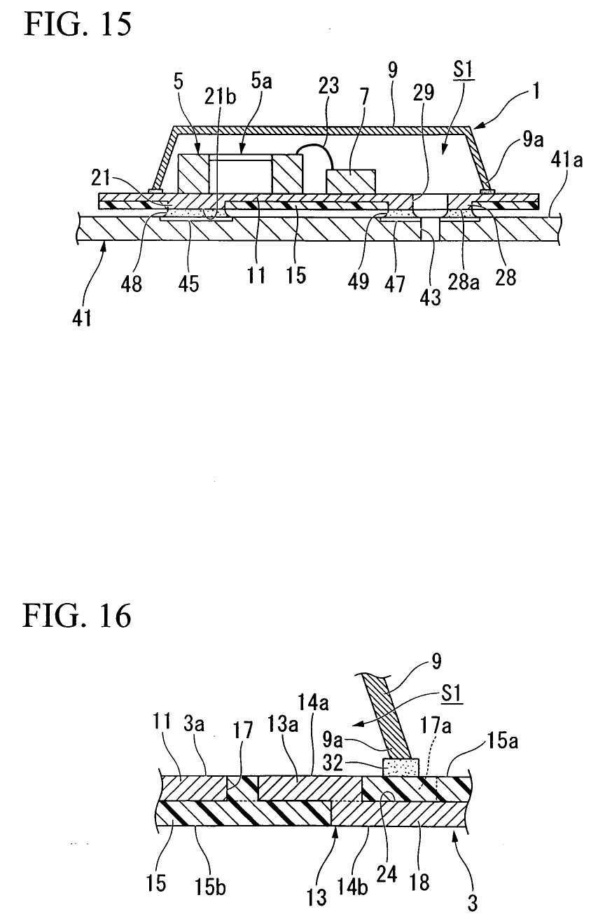

Next, a mounting structure adapted to the microphone package 1 will be described with reference to FIGS. 15 and 16.

As shown in FIG. 15, the microphone package 1 is mounted on a mounting surface 41a of a substrate (or a board) 41. Lands (not shown) which are electrically connected to the lead terminals 13 are formed on the mounting surface 41a, and a through-hole 43 is formed to run through the substrate 41 in the thickness direction so that the opening thereof is formed on the mounting surface 41a. The lands are positioned in correspondence with the external connection surfaces 14b of the lead terminals 13 and are thus electrically connected to them when the microphone package 1 is mounted on the mounting surface 41a of the substrate 41. A ground land 45 is formed on the mounting surface 41a of the substrate 41 at the prescribed position opposite to the external connection surface 21b of the ground terminal 21.

The through-hole 43 is positioned opposite to the through-hole 29 of the mold substrate 3. A ring-shaped joint land 47 is formed in the surrounding area of the through-hole 43 on the mounting surface 41a and is positioned opposite to the distal surface 28a of the ring-shaped projection 28.

When the microphone package 1 is mounted on the mounting surface 41a of the substrate 41, the backside 15b of the resin mold 15 of the mold substrate 3 is positioned to face the mounting surface 41a of the substrate 41, and then the external connection surfaces 14b of the lead terminals 13 are bonded to the lands formed on the mounting surface 41a of the substrate 41 via solder. Thus, the microphone chip 5 and the companion chip 7 are electrically connected to the substrate 41 via the lead terminals 13.

At this time, the external connection surface 21b of the ground terminal 21 is bonded to the ground land 45 on the mounting surface 41a via a solder 48. Thus, the cover 9 and the stage 11 are electrically connected to the ground pattern (not shown) of the substrate 41 via the ground land 45 and the solder 48, thus forming a shield (using the cover 9 and the stage 11) for blocking noise from entering into the cavity S1. The shield entirely covers the cavity SI except for the cutouts 17 (in which the cover 9 does not come in contact with the stage 11) and the through-hole 29 of the mold substrate 3, thus minimizing gaps allowing noise to enter into the cavity S1. That is, the microphone package 1 having the mold substrate 3 and the lead frame 33 can improve the shield performance.

When the microphone package 1 is mounted on the mounting surface 41a of the substrate 41, the through-hole 29 of the mold substrate 3 is positioned opposite to the through-hole 43 of the substrate 41, and then the distal surface 28a of the ring-shaped projection 28 is bonded to the ring-shaped joint land 47 via a solder 49, wherein the distal surface 28a of the projection 28 forms a joint surface joining the joint land 47. In this joint state, pressure variations such as sounds are sequentially propagated through the through-holes 43 and 29 so as to enter into the cavity S1, wherein the solder 49 for soldering the distal surface 28a of the projection 28 to the joint land 47 prevents pressure variations from leaking via gaps between the mold substrate 3 and the substrate 41.

The microphone package 1 having the mold substrate 3 and the lead frame 33 forms the joint surface to prevent sound leakage by way of the projection 28 integrally unified with the stage 11. This makes it easier for the manufacturer to manufacture the microphone package 1 reliably and avoid sound leakage in accordance with the resin mold technology, and at low cost.

Since the stage 11 and the projection 28 are formed by way of etching of the thin metal plate 31, the thickness of the resin mold 15 formed below the backside 11b of the stage 11 may match the etching depth. This makes it possible to define the thickness of the mold substrate 3 to be equivalent to the original thickness of the thin metal plate 31 before etching. That is, it is possible to reduce the overall thickness of the mold resin 3.

When the projection 28 is formed in connection with the stage 11 in the microphone package 1, it is unnecessary to process the surface 31a of the thin metal plate 31 (which forms the surface 3a of the stage 11); this makes the surface 3a of the stage 11 substantially planar without irregularities (or with a very small amount of irregularities). That is, it is possible to secure a sufficiently large area for mounting the microphone chip 5 and the companion chip 7 in the surface 3a of the stage 11.

In the manufacturing of the microphone package 1, the lead frame 33 is formed by way of half-etching on the stage 11, the interconnection leads 19, and the support leads 18 of the lead terminals 13 so that no bent portion exists in the lead terminals 13. This prevents the stage 11 and the lead terminals 13 from being deformed when the lead frame 33 is tightly held between the metal molds 103 and 104 in the molding process. This makes it possible for the manufacturer to easily manufacture the microphone package 1.

Due to the formation of the resin mold 15 surrounding the ground terminal 21 and the projection 28 which project from the backside 11b of the stage 11, the stage 11 is firmly engaged with the resin mold 15 via the ground terminal 21 and the projection 28. This improves the adhesion between the stage 11 and the resin mold 15 so as to prevent the stage 11 from being easily separated from the resin mold 15.

The microphone package 1 of the first embodiment is designed such that the thickness of the connectors 13a of the lead terminals 13 is identical to the original thickness of the thin metal plate 31; but this is not a restriction. For example, as shown in FIG. 16, the thickness of the connector 13a of the lead terminal 13 can be reduced to approximately a half of the original thickness of the thin metal plate 31 such that it is recessed from the external connection surface 14b, wherein a recessed step, which is recessed from the backside 15b of the mold resin 15 of the mold resin 3, is formed in the surrounding area of the external connection surface 14b of the lead terminal 13. In this modification, the resin mold 15 is formed on the recess 24 of the support lead 18 unified with the connector 13a of the lead terminal 13, while the resin mold 15 is also formed below the connector 13a, wherein the lead terminal is held on both sides thereof in the thickness direction by the resin mold 15. This further improves the adhesion between the lead terminals 13 and the resin mold 15 and therefore makes it possible to prevent the lead terminals 13 from being easily separated from the resin mold 15.

The recesses 24 are not necessarily formed on the entire surfaces of the support leads 18 of the lead terminals 13; that is, they can be formed in the limited areas of the support leads 18 as long as the cover 9 is not brought into contact with the support leads 18. In short, the first embodiment simply requires the recesses 24 (for mounting the opening edge 9a of the cover 9) to be expanded in the width directions of the support leads 18 positioned in the openings 17a of the cutouts 17.

The lead terminals 13 are not necessarily aligned along the first side 11c and the second side 11d of the stage 11 having a rectangular shape in plan view; that is, they can be aligned along only the first side 11c of the stage 11. In this case, no lead terminal 13 is aligned along the remaining three sides of the stage 11, which eliminates the necessity of forming the cutouts 17 for embracing the lead terminals 13 in the stage 11. In other words, this prevents gaps (formed by the cutouts 17) from being formed between the cover 9 and the remaining three sides of the stage 11. This reliably blocks noise from entering into the cavity S1 via the remaining three sides of the stage 11.

In the above, it is preferable to form a plurality of ground terminals (similar to the ground terminal 21), which project from the backside 11b of the stage 11, along the second side 11d of the stage 11. By aligning the ground terminals, it is possible to mount a semiconductor device on a substrate (or a board) in a stable manner.

### 2. Second Embodiment

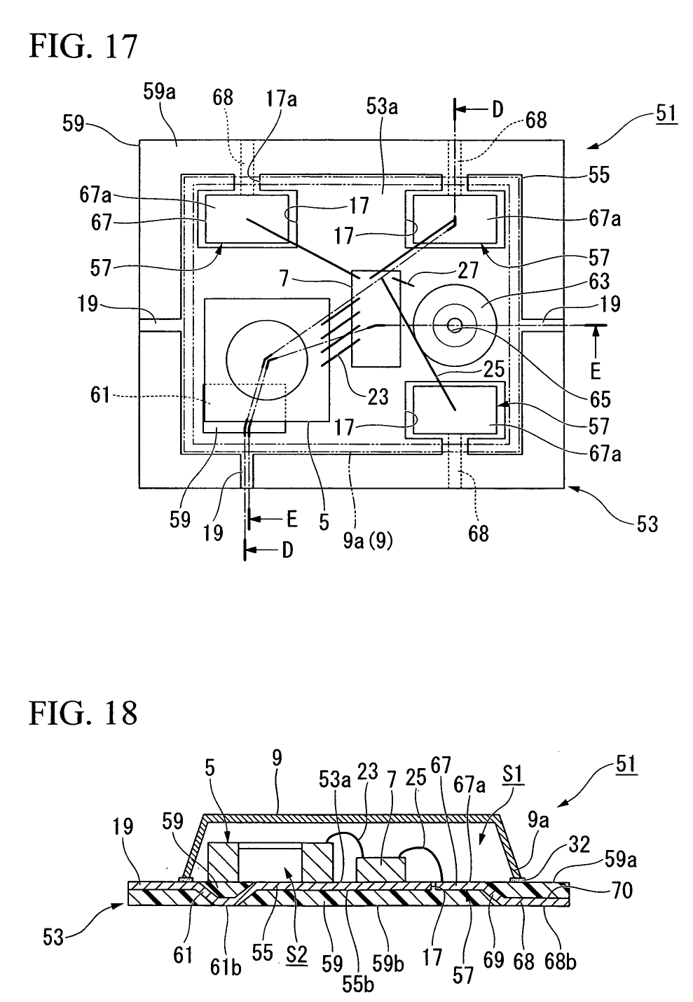

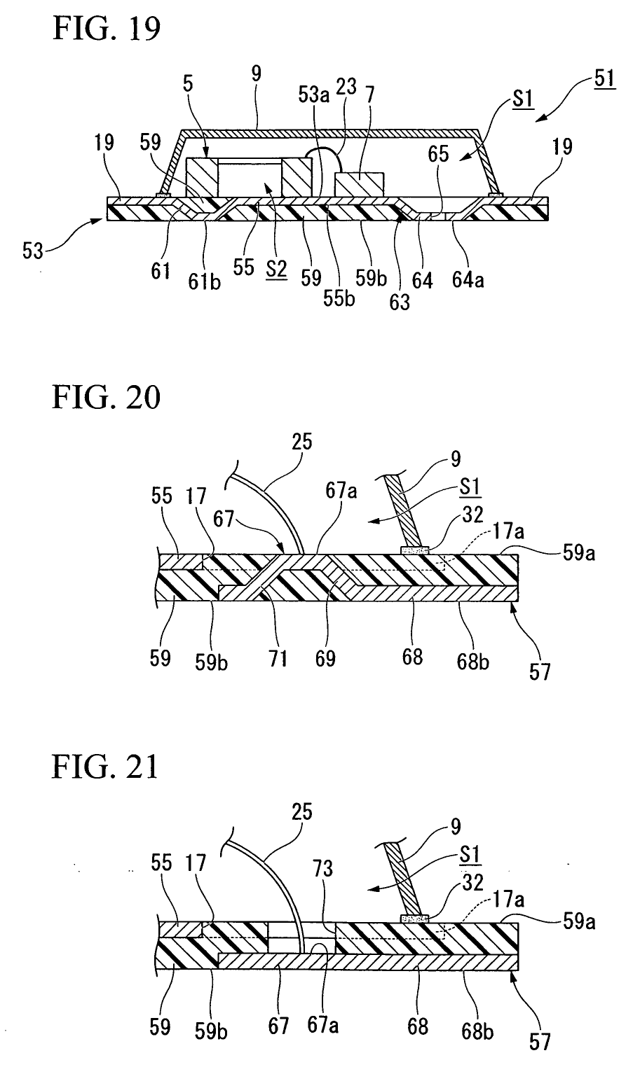

Next, a microphone package 51 according to a second embodiment of the present invention will be described with reference to FIGS. 17 to 19, wherein parts identical to those of the microphone package 1 of the first embodiment are designated by the same reference numerals; hence, duplicate descriptions thereof are simplified or omitted.

Similar to the microphone package 1, the microphone package 51 shown in FIGS. 17 to 19 has a mold substrate 53 having a rectangular plate shape in plan view. The mold substrate 53 includes a stage 55 (whose surface forms a surface 53a of the mold substrate 53), a plurality of lead terminals 57 which are electrically connected with the microphone chip 5 and the companion chip 7, and a resin mold (or an insulating member) for sealing the stage 55 and the lead terminals 57 in an electrically insulating manner.

The surface 53a of the stage 55 is exposed from a surface 59a of the resin mold 59 so as to form the same plane with the resin mold 59. A backside 55b and a side surface of the stage 55 are partially sealed with the resin mold 59.

The stage 55 is subjected to drawing so as to form a ground terminal 61 which is recessed from the surface 53a and also projects from the backside 55b. An external connection surface 61b of the ground terminal 61 is exposed from the backside 59b of the resin mold 59. The external connection surface 61b of the ground terminal 61 is made planar so as to form the same plane with the backside 59b of the resin mold 59, wherein it is connected to the external wiring (not shown).

A part of the resin mold 59 is formed above the ground terminal 61, wherein it is embedded in the recessed region of the ground terminal 61. The resin mold 59 forms the same plane with the surface 53a of the stage 55.

Similar to the ground terminal 61, the stage 55 is subjected to drawing so as to form a cylindrical projecting 63 having a cylindrical shape, which is recessed from the surface 53a and also projects from the backside 55b. The cylindrical projection 63 has a bottom portion 64 which is formed in a flat plate shape in parallel with the stage 55. An exterior surface (or a distal surface) 64a of the bottom portion 64 of the cylindrical projection 63 is exposed from the resin mold 59 so as to form the same plane with the backside 59b. A through-hole 65 is formed to run through the bottom portion 64 of the cylindrical projection 63 in the thickness direction. That is, the through-hole 65 and the inside of the cylindrical projection 63 form a sound hole which is opened on the surface 53a of the stage 55 so as to make the cavity S1 communicate with the external space. Due to the formation of the through-hole 65, the exterior surface 64a of the bottom portion 64 of the cylindrical projection 63 is formed in a ring shape.

The lead terminals 57 include connectors 67 which are positioned inside the cutouts 17 of the stage 55 and support leads 68 which are extended from the connectors 67 in the periphery of the stage 55.

The connectors 67 have internal connection surfaces 67a which are exposed from the surface 59a of the resin mold 59 in the cavity S1 so as to form the same plane with the surface 59a of the resin mold 59. The support leads 68, whose widths are smaller than the widths of the connectors 67, are positioned inside the openings 17a of the cutouts 17 in plan view, wherein they are further extended from the periphery of the stage 55.

Bent portions 69 are formed at the bases of the support leads 68 unified with the connectors 67. Due to the bent portions 69, the support leads 68 are entirely positioned below the surface 59a of the resin mold 59. In the microphone package 51 of the second embodiment, recessed portions 70, which are recessed from the surface 53a of the stage 55 due to the bent portions 69, are formed in the support leads 68 in the entirety. The distal ends of the support leads 68 (which are extended from the bent portions 69) have external connection surfaces 68b which are exposed from the resin mold 59 so as to form the same plane with the backside 59b.

Next, a manufacturing method of the microphone package 51 will be described. The manufacturing method of the microphone package 51 is basically similar to the manufacturing method of the microphone package 1 except for the mold substrate forming process, which is mainly described below while simplifying or omitting descriptions of other processes.

In the mold substrate forming process of the second embodiment, similar to the first embodiment, a metal thin plate (not shown) composed of copper is subjected to press working and etching, thus performing a lead frame forming process for forming a lead frame in which the lead terminals 57 and the interconnection leads 19 project inwardly of a frame, and the interconnection leads 19 are interconnected to the stage 55 formed inside the frame. In the lead frame forming process, the cutouts 17 and the through-hole 65 are formed in the stage 55, and the connectors 67 of the lead terminals 57 are positioned inside the cutouts 17.

The lead frame is subjected to press working in a pressing process, thus forming the ground terminal 61 and the cylindrical projection 63 in the stage 55 while forming the bent portions 69 in the lead terminals 57. In the pressing process, specifically, both the ground terminal 61 and the cylindrical projection 63 are formed via drawing, while the bent portions 69 are formed at the bases of the support leads via bending. The drawing and bending are performed until all the external connection surface 61b of the ground terminal 61, the exterior surface 64a of the cylindrical projection 63, and the external connection surfaces 68b of the support leads 68 are positioned in the same plane.

The pressing process can be performed before and after the lead frame forming process. After the formation of the cylindrical projection 63, it is possible to form the through-hole 65, for example. Through these processes, only a single lead frame can be extracted from a single thin metal plate, or a plurality of lead frames can be extracted from a single thin metal plate.

After completion of the above processes, a molding process is performed to seal the lead frame with the resin mold 59. In the molding process of the second embodiment similar to the first embodiment, the lead frame is tightly held by a metal mold (not shown) in the thickness direction, and then the interior space of the metal mold is filled with a resin (or an insulating material), thus forming the resin mold 59. During the filling of the resin, the metal mold is closed in an airtight manner so as to prevent the resin from entering into the inside of the cylindrical projection 63 and the through-hole 65. During the filling of the resin inside the ground terminal 61, the metal mold is not closed in an airtight manner.

After the molding process, a cutting process is performed in a similar manner to the first embodiment, thus completing the production of the mold substrate 53.

Similar to the microphone package 1 of the first embodiment, the microphone package 51 of the second embodiment is mounted on a mounting surface of a substrate or a board (not shown). When the microphone package 51 is mounted on the substrate, the backside 59b of the resin mold 59 of the mold substrate 53 is positioned to face the mounting surface of the substrate, and then the external connection surfaces 68b of the lead terminals 57 are bonded to lands of the substrate via solder, the external connection surface 61b of the ground terminal 61 is bonded to a ground land of the substrate via solder, and the exterior surface 64a of the projection 63 is bonded to a joint land of the substrate via solder.

The microphone package 51 whose lead frame is sealed with the mold substrate 53 offers the following effects, similar to the effects of the microphone package 1.
(1) Since the exterior surface 64a of the cylindrical projection 63 is bonded to the joint land of the substrate via solder, it is possible to prevent sound from being leaked via gaps between the mold substrate 53 and the substrate. It is possible to easily produce at low cost the microphone package 51 capable of preventing sound leakage in accordance with the resin mold technology.
(2) A shield is formed by bonding the ground terminal 61 to the ground land of the substrate so as to cover the cavity S1 except for the cutouts 17 and the through-hole 65 in which the cover 9 does not come in contact with the stage 55, thus improving the shield performance.
(3) Since the resin mold 59 is formed in the surrounding area of the ground terminal 61 and the cylindrical projection 63 which project from the backside 55b of the stage 55, the stage 55 is firmly engaged with the resin mold 59 via the ground terminal 61 and the cylindrical projection 63. Therefore, it is possible to further improve the adhesion between the stage 55 and the resin mold 59, thus preventing the stage 55 from being separated from the resin mold 59 with ease.
(4) Since the resin mold 59 is formed above the support leads 68 and below the connectors 67, the lead terminals 57 are tightly held by the resin mold 59 in the thickness direction. Therefore, it is possible to further improve the adhesion between the lead terminals 57 and the resin mold 59, thus preventing the lead terminals 57 from being separated from the resin mold 59 with ease.

The microphone package 51 of the second embodiment can be further modified in a variety of ways, which will be described below.

In the second embodiment, the cylindrical projection 63 having the bottom portion is formed in the stage 55 via drawing; but this is not a restriction. For example, it is possible to form a cylindrical projection not having the bottom portion via burring.

The recesses are not necessarily formed on the entire surfaces of the support leads 68. For example, the intermediate portions of the support leads 68 in the cutouts 17 of the stage 55 are bent so as to form recesses thereby, wherein the distal ends of the support leads 68 are exposed from the surface 59a of the resin mold 59. In this case, the external connection surfaces 68b, which are exposed from the backside 59b of the resin mold 59, are formed in the intermediate portions of the support leads 68.

The connectors 67 of the lead terminals 57 are each formed in a simple plate shape so as to form the internal connection surfaces 67a thereon; but this is not a restriction. As shown in FIG. 20, for example, a bent portion 71 is formed in the connector 67 in a similar way to the bent portion 69 of the support lead 68 and is partially embedded in the resin mold 59. Due to the formation of the bent portion 71, a part of the connector 67 is exposed from the backside 59b of the resin mold 59. It is preferable that the internal connection surface 67a be sandwiched between the bent portion 71 of the connector 67 and the bent portion 69 of the support lead 68. Thus, it is possible to further improve the adhesion between the connector 67 and the resin mold 59, thus preventing the connector 67 from being separated from the resin mold 59.

The internal surfaces 67a of the connectors 67 are not necessarily positioned to form the same plane with the surface 59a of the resin mold 59. The second embodiment simply requires that the internal connection surfaces 67a be exposed in the cavity S1. That is, as shown in FIG. 21, both the connector 67 and the support lead 68 are formed in a simple plate shape without forming the bent portions 69 and 71 in the lead terminal 57, wherein they are exposed from the backside 59b of the resin mold 59. In this case, the external connection surface 68b is continuously formed across the connector 67 and the support lead 68. This constitution additionally needs an opening 73 which is recessed from the surface 59a of the resin mold 59 to reach the surface 67a of the connector 67.

The mold substrate 53 is not necessarily formed in a plate shape; hence, it can be formed in a box shape having a bottom portion. In this case, a part of the resin mold 59 surrounding the stage 55 is elevated to be higher than the surface 53a of the mold substrate 53, wherein the side wall of the mold substrate 53 is formed using the resin mold 59.

In the above, the cover 9 is not necessarily formed in the box shape having the bottom portion. For example, the cover 9 can be formed in a plate shape which is simply attached onto the upper edge of the side wall of the mold substrate 53. The cover 9 having a plate shape is electrically connected to the stage 55 in such a way that the interconnection leads 19 are subjected to bending and are thus partially exposed from the upper edge of the side wall of the resin mold 53, for example.

When a plurality of lead frames is extracted from a single thin metal plate in accordance with the manufacturing method of the microphone package 51, a plurality of resin molds 59 is not necessarily formed with respect to individual pieces of lead frames; hence, the resin mold 59 can be formed in connection with multiple lead frames, wherein the frame therefor may be partially arranged inside the resin mold 59.

When the joint lands form the ground pattern of the substrate in the first and second embodiments, it is possible to electrically connect the stages 11 and 55 to the ground pattern by simply making the projections 28 and 63 (which are integrally unified with the stages 11 and 55) join the joint lands 45. In this case, it is possible to simply form the shield (for blocking noise from entering into the cavity S1) without forming the ground terminals 21 and 61 in the stages 11 and 55 independently.

The microphone packages 1 and 51 according to the first and second embodiments can be modified in such a way that the resin molds 15 and 59 are formed inside through-holes which run through the stages 11 and 55 in the thickness directions without the areas for mounting the microphone chip 5 and the companion chip 7. In this modification, due to the anchor effect caused by resins being embedded in through-holes, it is possible to further improve the adhesion between the stages 11 and 55 and the resin molds 15 and 59. It is preferable that through-holes be formed at prescribed positions which do not deteriorate the shielding effects of the microphone packages 1 and 51.

The interconnection leads 19 integrally unified with the stages 11 and 15 are not necessarily exposed externally from the surfaces 15a and 59a of the resin molds 15 and 59. Instead, the interconnection leads 19 can be exposed externally from the backsides 15b and 59b of the resin molds 15 and 59. In this modification, the interconnection leads 19 can be formed by way of half-etching on the surface 31a of the thin metal plate 31, or they can be bent downwardly below the stages 11 and 55 by way of press working.

In the above modification, the resin molds 15 and 59 are formed above the interconnection leads 19 and below the stages 11 and 55, wherein the interconnection leads 19 integrally unified with the stages 11 and 55 are tightly held by the resin molds 15 and 59 in the thickness directions, thus it is possible to further improve the adhesion between the stages 11 and 55 and the resin molds 15 and 59.

Similar to the support leads 18 and 68, which project externally from the peripheries of the stages 11 and 55, the interconnection leads 19, which are interconnected to frames of lead frames, are exposed from the backsides 15b and 59b of the resin molds 15 and 59. This makes it possible to easily and speedily form individual pieces of mold substrates 3 by way of press working. That is, it is possible to improve the manufacturing efficiency of microphone packages.

In this connection, the interconnection leads 19 can be formed in connection with the ground terminals 21 and 61.

The microphone chip 5 and the companion chip 7 are not necessarily fixed onto the surfaces 3a and 53a of the stages 11 and 55 via insulating solder pastes. The present invention simply requires that the microphone chip 5 and the companion chip 7 be mounted on the surfaces 3a and 53a of the stages 11 and 55. For example, it is possible to prepare a base mold composed of a resin in connection with each of the stages 11 and 55, wherein the microphone chip 5 and the companion chip 7 are fixed onto the base mold.

In the manufacturing of the mold substrates 3 and 53, the base mold can be formed simultaneously with the resin molds 15 and 59. Herein, it is necessary that the base mold be formed in a restricted area on the surfaces 3a and 53a of the stages 11 and 55 except for the disposing area for mounting the opening edge 9a of the cover 9 and the areas for forming sound holes.

The opening edge 9a of the cover 9 is not necessarily mounted on the peripheries of the surfaces 3a and 53a of the stages 11 and 55. That is, the opening edge 9a of the cover 9 must be disposed on the surfaces 3a and 53a of the stages 11 and 55 in such a way that the microphone chip 5, the companion chip 7, and the internal connection surfaces 14a and 67a of the lead terminals 13 and 57 be embraced inside the cavity S1. In other words, the opening edge 9a of the cover 9 must be partially connected to the stages 11 and 55 while being insulated from the lead terminals 13 and 57. It is possible to dispose the opening edge 9a of the cover 9 inwardly of the periphery of the stage 11 except for the internal connection surfaces 14a and 67a of the lead terminals 13 and 57 and the areas for mounting the microphone chip 5 and the companion chip 7.

The opening edge 9a of the cover 9 can be connected to the surfaces 3a and 53a of the stages 11 and 55 in contact with the interconnection leads 19. In this connection, the opening edge 9a of the cover 9 is brought into contact with the interconnection leads 19 and is electrically connected to the surfaces 3a and 53a of the stages 11 and 55 via conductive members which are arranged between the opening edge 9a of the cover 9 and the surfaces 3a and 53a of the stages 11 and 55, for example. This increases the total contact area between the cover 9 and the stages 11 and 55, thus improving the reliability in fixing the positional relationship between the cover 9 and the stages 11 and 55.

The cover 9 is not necessarily fixed to the mold substrates 3 and 53 via the conductive adhesive 32. The cover 9 can be fixed to the mold substrates 3 and 53 via solder. In this case, the cover 9 is fixed to the mold substrates 3 and 53 while simultaneously soldering the mold substrates 3 and 53, which are electrically connected to the microphone chip 5 and the companion chip 7 mounted thereon, to the mounting surface of a substrate by way of a reflow process.

The support leads 18 and 68 are partially exposed externally of the cutouts 17; but this is not a restriction. That is, the support leads 18 and 68 can be entirely positioned inside the cutouts 17. In other words, the lead terminals 13 and 57 can be entirely positioned inside the cutouts 17 of the stages 11 and 55.

The lead terminals 13 and 57 are not necessarily arranged inside the cutouts 17 because the present invention requires that the lead terminals 13 and 57 be arranged in proximity to the stages 11 and 55 with gaps therebetween. For example, the lead terminals 13 and 57 can be aligned in proximity to the peripheries of the stages 11 and 55 having no recess 17. This modification allows the opening edge 9a of the cover 9 to be mounted on the surfaces 3a and 53a of the mold substrates 3 and 53 by way of the recesses 24 and 70 of the support leads 18 and 68. Herein, the cover 9 is electrically connected to the stage 11 by disposing the opening edge 9a of the cover 9 on the interconnection leads 19.

Both the microphone package 1 and 51 are designed to arrange the companion chip 7 on the surfaces 3a and 53a of the stages 11 and 55; but this is not a restriction because the present invention simply requires that at least the microphone chip 5 is arranged therein. In this case, the companion chip 7 is independently mounted on the mounting surface of a substrate for mounting the microphone packages 1 and 51, wherein the microphone packages 1 and 51 each including the microphone chip 5 are electrically connected to the companion chip 7.

Lastly, the present invention is not necessarily limited to the embodiments, which are illustrative and not restrictive and which can be further modified in a variety of ways within the scope of the invention as defined in the appended claims.

What is claimed is:

1. A microphone package comprising:
a housing having a hollow cavity and a sound hole; and
a microphone chip which is arranged inside the housing so as to detect pressure variations applied thereto via the sound hole,
wherein the housing comprises
a mold substrate for mounting the microphone chip on a surface thereof, and
a cover having a rectangular shape, which is combined with the mold substrate so as to form the hollow cavity for embracing the microphone chip,
wherein the mold substrate comprises
a stage having conductivity for mounting the microphone chip thereon,
a plurality of lead terminals having conductivity, which are electrically connected to the microphone chip, and
a resin mold having an insulating property, which electrically insulates the stage from the plurality of lead terminals, and
wherein the sound hole is formed by way of a cylindrical projection which integrally projects from a backside of the stage and whose distal surface is exposed externally from a backside of the resin mold.

2. A microphone package according to claim 1, wherein the stage and the plurality of lead terminals are formed using a lead frame composed of a thin metal plate.

3. A microphone package according to claim 1, wherein the cover having conductivity is formed in a box shape having a bottom portion and an opening edge,
wherein a plurality of cutouts is formed in a periphery of the stage,
wherein the lead terminals are constituted of connectors, which are arranged inside the cutouts and whose internal connection surfaces are exposed in the hollow cavity and are electrically connected to the microphone chip, and support leads which are extended externally from the connectors in the periphery of the stage and whose distal ends are exposed on a side surface of the mold substrate,
wherein a plurality of recesses are formed on the support leads in width directions and are embedded with the resin mold, and
wherein the opening edge of the cover is mounted on the surface of the stage and the resin mold embedded in the recesses of the support leads.

4. A mounting structure for mounting a microphone package, which is constituted of a housing having a hollow cavity and a sound hole, and a microphone chip which is arranged inside the housing so as to detect pressure variations applied thereto via the sound hole, on a mounting surface of a substrate,
wherein the housing is constituted of a mold substrate for mounting the microphone chip on a surface thereof, and a cover having a rectangular shape which is combined with the mold substrate so as to form the hollow cavity for embracing the microphone chip,
wherein the mold substrate includes a stage having conductivity for mounting the microphone chip thereon, a plurality of lead terminals having conductivity which are electrically connected to the microphone chip, a ground terminal, and a resin mold having an insulating property which electrically insulates the stage from the plurality of lead terminals,
wherein the sound hole is formed by way of a cylindrical projection which integrally projects from a backside of the stage and whose distal surface is exposed externally from a backside of the resin mold.
wherein the substrate includes a through-hole which is positioned opposite to the sound hole of the mold substrate, at least one land which is electrically connected to the lead terminals and the ground terminal, and a joint land which is formed in a surrounding area of the through-hole and is positioned opposite to the distal surface of the cylindrical projection, and
wherein the distal surface of the cylindrical projection is joined with the joint land via a solder.

5. A mounting structure according to claim 4, wherein the cover having conductivity is formed in a box shape having a bottom portion and an opening edge,
wherein a plurality of cutouts is formed in a periphery of the stage,
wherein the lead terminals are constituted of connectors, which are arranged inside the cutouts and whose internal connection surfaces are exposed in the hollow cavity and are electrically connected to the microphone chip, and support leads which are extended externally from the connectors in the periphery of the stage and whose distal ends are exposed on a side surface of the mold substrate,
wherein a plurality of recesses is formed on the support leads in width directions and are sealed with the resin mold, and
wherein the opening edge of the cover is mounted on the surface of the stage and the resin mold embedded in the recesses of the support leads.

6. A mold substrate comprising:
a stage having a rectangular shape which mounts a microphone chip for detecting pressure variations on a surface thereof;
a plurality of lead terminals which are aligned in proximity to the stage with gaps therebetween and are electrically connected to the microphone chip; and
a resin mold having an insulating property which electrically insulates the stage from the plurality of leads,
wherein each of the lead terminals has an internal connection surface which is exposed externally of the resin mold formed above the surface of the stage, and an external connection surface which is exposed externally of the resin mold below a backside of the stage,
wherein a cylindrical projection having a through-hole, which runs through the stage in a thickness direction, is integrally formed to project from the backside of the stage, and
wherein a distal surface of the cylindrical projection is exposed externally of the resin mold below the backside of the stage.

7. A lead frame comprising:
a stage having a rectangular shape which mounts a microphone chip for detecting pressure variations on a surface thereof;
a plurality of lead terminals which are aligned in proximity to the stage with gaps therebetween and are electrically connected to the microphone chip; and
a plurality of interconnection leads for integrally unifying the plurality of lead terminals to the stage,
wherein a cylindrical projection having a through-hole, which runs through the stage in a thickness direction, is integrally formed to project from a backside of the stage.
